(19) United States
(12) Patent Application Publication
(10) Pub. No.: US 2010/0097314 A1
(43) Pub. Date: Apr. 22, 2010

(54) DRAWING CONTROL APPARATUS AND DRAWING CONTROL METHOD OF ELECTRONIC PAPER

(75) Inventors: Yuji Ueno, Inagi (JP); Yoshinori Ito, Inagi (JP)

Correspondence Address: GREER, BURNS & CRAIN, 300 S WACKER DR, 25TH FLOOR, CHICAGO, IL, 60606, US

(73) Assignee: FUJITSU FRONTECH LIMITED, Tokyo (JP)

(21) Appl. No.: 12/649,070

(22) Filed: Dec. 29, 2009

Related U.S. Application Data
(63) Continuation of application No. PCT/JP2007/001499, filed on Dec. 28, 2007.

(51) Int. Cl. G09G 5/00

(52) U.S. Cl. 345/156

(57) ABSTRACT

When a user inputs an instruction to display a subsequent screen from an operation unit 14 while electronic paper 16 is displaying a screen, application 21 detects the input (t9). Firmware transmits a request to stop the display to an EP control unit 15 (t31) and the EP control unit 15 makes the electronic paper 16 stop the display (t32). Upon receipt of the request (t33), the EP control unit 15 returns a display status to the firmware (t34). Upon receipt of this status, the firmware returns a status of “non-drawing” to the application 21 (t41). The application 21 notifies the firmware of the information of an area to be newly displayed (t43). The firmware transmits this information to the EP control unit 15 with a request to start the display (T44). The EP control unit 15 makes the electronic paper 16 start displaying a new area (t45).

### CROSS REFERENCE TO RELATED APPLICATION

This application is a continuation of PCT application of PCT/JP2007/001499, which was filed on Dec. 28, 2007.

### FIELD

The present invention relates to electronic paper, and more particularly to a drawing technology of electronic paper.

### BACKGROUND

By the development of thin electronic display, electronic paper which is thin like paper and onto/from which data can be electrically written/erase is realized. Since electronic paper is thin like paper and also light, it is superior in portability. Furthermore, since data displayed on a screen can be rewritten, the space of newspaper, the contents of a book and the like can be browsed as if their pages were turned over.

As a typical display device of electronic paper, a liquid crystal display, an organic EL (electro-luminescence) display or the like is included. A practical liquid crystal display for electronic paper uses cohlesteric liquid crystal as liquid crystal. The optical characteristics of cohlesteric liquid crystal changes among a planer state (under no applied voltage), a focal-conic state (under low applied voltage) and a homeotropic state (under high applied voltage) according to the electric field intensity of cohlesteric liquid crystal. Since cohlesteric liquid crystal has such optical characteristics, it can express the lightness/darkness of light by its selective reflection and desired data display is possible by the control of driving voltage. Micro-capsule electrophoretic migration type electric paper using black and white fine-grains is also known (see Patent document 1).

The screen display of electronic paper is largely classified into a case where display on the entire screen is rewritten (full screen rewrite) and a case where part of a screen is rewritten (partial screen rewrite). A setting screen, operational instruction buttons and the like are displayed on an electronic paper screen of some terminal with a touch panel mounted at the top of electronic paper and various settings and operational instructions can be executed by pushing the display screen of electronic paper by an input pen or the like. The push position on the screen of an input pen is detected by the touch panel. In many cases, the partial rewrite of the screen is made on the setting screen and the like. On the setting screen, operation is frequently made and the frequency of rewrite is also high. Meanwhile, in the full screen rewrite, in many cases, screens are read in units of pages, as in electronic book and the like.

In electronic paper using a liquid crystal display element for screen display, for example, when display is made in 4096 colors by a frame rate gradation method, three times of full screen drawing is necessary. The frame rate gradation method is, for example, a display method in which one screen is built up by three frames and its gradation display is made by respective frames. Thus, for example, display can be made in 4096 colors, according to the gradation combination of respective frames. In screen drawing, the frames are displayed by sequentially scanning the screen one line by one line from its left end toward its right last. Therefore, a time required to display one screen becomes equal to the total display time of three frames. In the case of A4 XGA (extended graphics array) specification, a screen is composed of 1024×768 pixels. On a screen in XGA specification, the display of one frame requires the scanning of 1024 lines (or 768 lines). Therefore, when multicolored display is made, a time required to display the entire screen becomes long. When an image on the screen is updated, it is necessary to return the alignment of liquid crystal molecules in the image update area to its initial state before a new image is written, from the nature of liquid crystal. This operation is called “reset”. In the case of normally white mode, a reset area becomes white. In a liquid crystal display, an image is updated by resetting the previous image (making display white) and then displaying a new image. Thus, the update of the colored image of a liquid crystal display requires both “reset” and “plural times of frame display”, it takes much time.

The current screen display method of electronic paper whose display unit is a colored liquid crystal display will be explained below. FIG. 1 is a sequence chart of the screen display control of a terminal whose display unit is electronic paper. The terminal is, for example, an electronic book.

The configuration of a terminal, the screen display of whose display unit (electronic paper, in this case) is controlled by the sequence illustrated in FIG. 1 will be briefly explained below. Electronic paper includes a touch panel as a operation unit for a user. The software of electronic paper is composed of application software (hereinafter called “application”), firmware and the like. The screen display of electronic paper is controlled by a control unit (hereinafter called “EP control unit”). The touch panel operation of a user is detected by the application. It is assumed that the screen display of electronic paper is made by line scanning.

The operation of the above-described terminal in the case where the display of a subsequent screen is instructed while electronic paper is displaying a screen will be explained below with reference to FIG. 1.

When a user inputs an instruction to display a subsequent screen from a touch panel (t1), the touch panel detects the input and outputs its detection signal to application (t2). Upon receipt of the detection signal from the touch panel, the application generates “drawing information” on the basis of the detection signal and outputs the drawing information to firmware (t3). This drawing information is composed of information for specifying a drawing area on the screen and the like. In the case of partial screen rewrite, for example, it includes information specifying the leading and last lines of a drawing area and the like. It also includes the drive voltage setting value of electronic paper, a driving time, times of drawing (one time of scan, three times of scan, etc.), drawing direction and the like.

When drawing information is inputted from the application, the firmware transmits a request for display to the EP control unit (t4). In this example, since the electronic paper is not currently displaying a screen, the EP control unit returns a display status of “non-display (un-displayed)” (t5). Upon receipt of the display status, the firmware transmits a “display start request” to the EP control unit (t6). Upon receipt of the request, the EP control unit controls the electronic paper according to the drawing information and makes the electronic paper start screen display (t7).

Then, when the user inputs an instruction to display a subsequent screen via the touch panel (t8), the application detects the input (t9) and outputs drawing information specified by the user to the firmware) (t10). When the drawing information is inputted, the firmware transmits a request for a display status to the EP control unit (t11). Since the electronic paper is currently displaying a screen, the EP control unit returns a display status of “during display” to the firmware (t12). Upon receipt of the display status, the firmware notifies the application of an “error” (t13).

Upon receipt of the error notice, the application outputs a “display start request” to the firmware after a predetermined waiting time (t14). Upon receipt of the display start request, the firmware transmits a display start request to the EP control unit again (t15).

Since the electronic paper is still displaying a screen at this moment, the EP control unit returns a status of “during display” to the firmware again (t16). Upon receipt of the display status, the firmware notifies the application of an “error” to the application again (t17).

Upon receipt of the error notice from the firmware, the application transmits a “display start request” to the firmware again after a predetermined waiting time (t18). Upon receipt of the display start request, the firmware transmits the third “display status request” to the EP control unit (t19).

Since the screen display of the electronic paper is already completed when the EP control unit receives the display status request, the EP control unit returns a display status of “non-display” to the firmware (t20). Upon receipt of the display status, the firmware transmits a command of “display start request” to the EP control unit (t21). Upon receipt of the command of a display start request from the firmware, the EP control unit makes the electronic paper start displaying a subsequent screen according to the command (t22).

Thus, when a user inputs an instruction to display a subsequent screen, the display control of the conventional electronic paper continues the current screen display if the electronic paper is displaying a screen and after the screen display is completed, it displays the subsequent screen. This is because when the drawing of the currently displayed screen (hereinafter called “previous specified screen”) is stopped and it moves to a subsequent screen, there is a possibility that an un-drawn area (un-displayed area) may occurs in the previous specification screen. Since the un-displayed area remains in the reset state, it is displayed in white.

However, if the drawing of the currently displayed screen is continued to the end although the display of a subsequent screen is instructed, it makes a response time to the user (time until a subsequent screen is actually displayed after the user instructs to display the subsequent screen) long. In the use of electronic paper, sometimes the user desires to immediately skip the currently displayed screen on the way and move to a subsequent screen. Furthermore, on the setting screen and the like, operations frequently occur and the rewriting of an image often happens. In such cases, since a time until a subsequent screen is displayed is long, the user irritates. Thus, the control of the conventional electronic paper has several problems in its user's operability.

Patent document 1: Japanese Laid-open Patent publication No. 2004-233603

### SUMMARY

It is an object of the present invention to promptly display a screen specified by a user, thus improving its user's operability.

The present invention presumes the display control apparatus of electronic paper, for controlling the display of electronic paper.

The first aspect of the display control apparatus of electronic paper, of the present invention includes a detection unit for detecting an input for instructing to display a subsequent screen and a control unit for controlling electronic paper to stop the screen display and start the display of the subsequent screen if electronic paper is displaying a screen when an input for instructing to display a subsequent screen is detected by the detection unit.

The second aspect of the display control apparatus of electronic paper, of the present invention further includes an acquisition unit for obtaining information of an un-displayed area resulted from the stoppage of the screen display in the first aspect of the display control apparatus of electronic paper. In this case, when determining that the subsequent screen display is the display of the partial screen area of the electronic paper and also the un-displayed area is not included in the display area of the subsequent screen on the basis of the information of the un-displayed area obtained by the acquisition unit, the control unit controls the electronic paper to display the image of the un-displayed area. In this case, the control unit can also make the electronic paper start displaying the subsequent screen, for example, after making it display the entire un-displayed area again. Alternatively, it can make the electronic paper start displaying the subsequent screen, for example, after making it display only the un-displayed area again.

According to the display control apparatus of the electronic paper of the present invention, having the above-described configuration, if a user instructs to display a subsequent screen while the electronic paper is currently displaying a screen, the display of the subsequent screen immediately starts. In this case, when screen display fails if only a subsequent screen is displayed, as to a screen whose display is stopped, a portion not displayed by display stoppage is also displayed.

Therefore, even while the electronic paper is displaying a screen, a screen newly specified by a user (a subsequent screen) can be promptly displayed without any trouble in displaying the screen.

### BRIEF DESCRIPTION OF DRAWINGS

FIG. 1 is a sequence chart illustrating the control method for switching over from the currently displayed screen to a subsequent screen in the conventional electronic paper;

FIG. 2 is a block diagram illustrating the system configuration of an electronic terminal using electronic paper to which the embodiment of the present invention is applied as its display unit;

FIG. 3 illustrates a configuration related to the screen display of the electronic terminal of the embodiment of the present invention separating software and hardware;

FIG. 4 illustrates the first sequence in the case where a user requests for a subsequent screen while the electronic paper is displaying a screen;

FIG. 5 illustrates the second sequence in the case where a user requests for a subsequent screen while the electronic paper is displaying a screen;

FIG. 6 illustrates the third sequence in the case where a user requests for a subsequent screen while the electronic paper is displaying a screen;

FIG. 7 is a flowchart illustrating the process algorithm of the sequence of the subsequent screen display illustrated in FIG. 5, of the major part of the present invention;

FIG. 8 is a flowchart illustrating the process algorithm of the sequence of the subsequent screen display illustrated in FIG. 6, of the major part of the present invention;

FIG. 9 is the first embodiment of the screen display method of electronic paper in the case where a user consecutively requests for the partial rewrite of a screen; and

FIG. 10 is the second embodiment of the screen display method of electronic paper in the case where a user consecutively requests for the partial rewrite of a screen.

### DESCRIPTION OF EMBODIMENTS

The preferred embodiments of the present invention will be explained below with reference to the drawings.

### [Configuration]

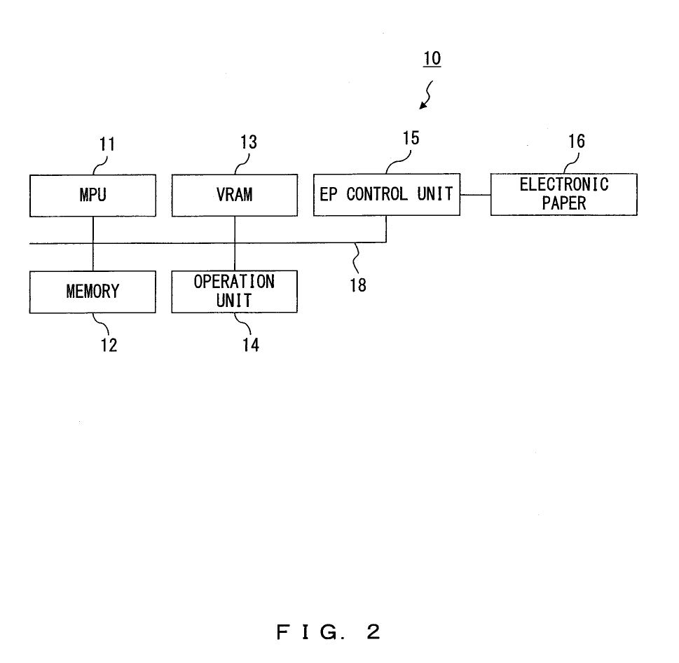

FIG. 2 is a block diagram illustrating the system configuration of an electronic terminal using electronic paper to which the embodiment of the present invention is applied as its display unit.

The electronic terminal 10 illustrated in FIG. 2 includes a MPU (micro-processing unit) 11, memory 12, VRAM (video random-access memory) 13, an operation unit 14, an EP control unit 15 and electronic paper 16. The MPU 11 is connected to the memory 12, the VRAM (video random-access memory) 13, the operation unit 14, the EP control unit 15 and the electronic paper 16 via a bus 18. The EP control unit is connected to the electronic paper 16.

The MPU 11 functions as a CPU (central processing unit) for controlling the entire system of the electronic terminal 10. The memory 12 is composed of ROM (read-only memory) and RAM (random-access memory). The ROM stores firmware. This firmware is composed of software, such as an OS (operating system), a driver (software) for the electronic paper 16, and the like. The application software (hereinafter called “application”) is stored in the RAM. Alternatively, application 21 can be stored in the ROM. The RAM is also used as a working area when the MPU 11 executes the firmware or the application and performs a process. The VRAM 13 stores data (display data) displayed on the screen of the electronic paper 16. The VRAM 13 stores the image data of all the pixels on the screen of the electronic paper 16. This image data is, for example, the gradation values of respective RGB. The operation unit 14 is, for example, a touch panel. When the operation unit 14 is a touch panel, this touch panel is mounted on the electronic paper 16. This touch panel is sometimes built in the electronic paper 16. Since the touch panel is transparent, an image displayed on the screen of the electronic paper 16 transmits through the touch panel. Therefore, a user can recognize the image of the electronic paper 16. The EP control unit 15 controls the screen display of the electronic paper 16. It also obtains the information of the current screen display state as status information. The electronic paper 16 is the display unit of the electronic terminal 10, composed of a display device, such as a liquid crystal display panel, an organic EL display or the like.

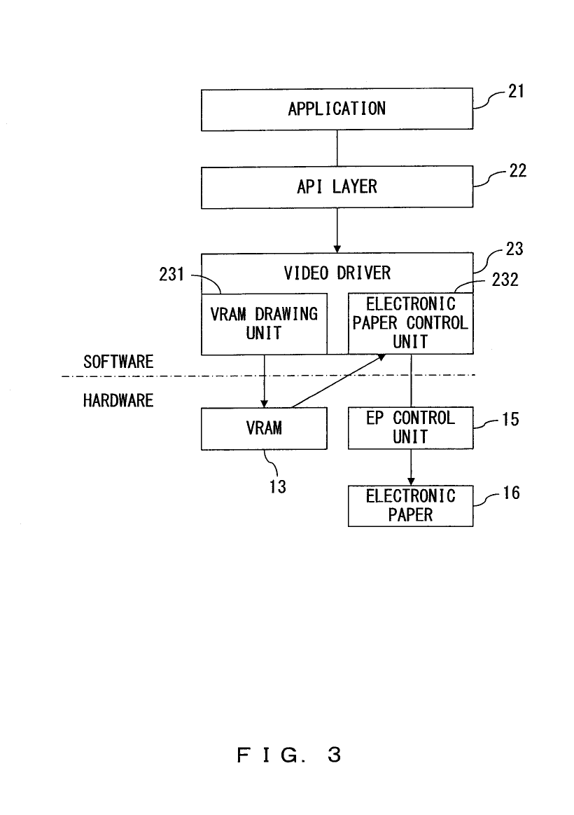

FIG. 3 illustrates a configuration related to the screen display of the electronic terminal of the embodiment of the present invention, separating software and hardware.

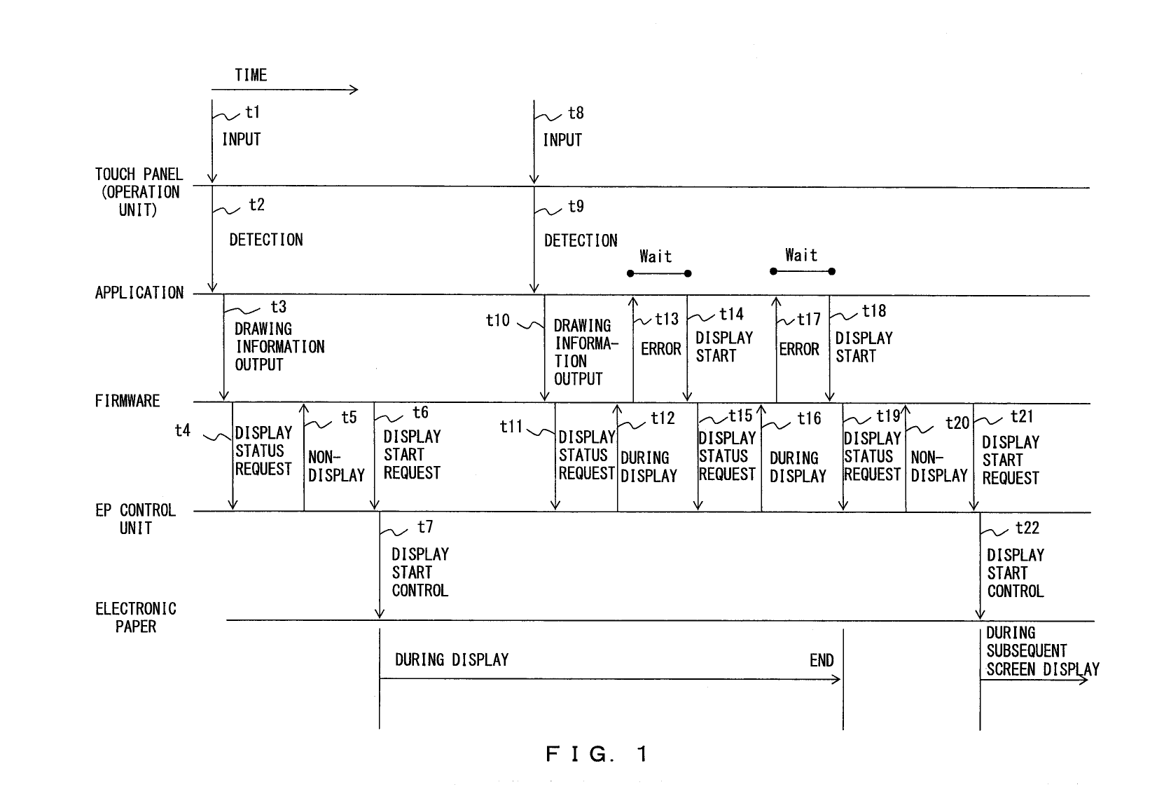

The software stored in the memory 12 illustrated in FIG. 2 includes application 21, an API layer 22, a video driver 23 and the like. The above-described firmware is composed of the API layer 22, the video driver 23 and the like. The application 21 is sometimes included in the firmware. The video driver 23 includes a VRAM drawing unit 231 and an electronic paper control unit 232 (software). The hardware is composed of the VRAM 13 illustrated in FIG. 1, the EP control unit 15 and the electronic paper 16.

The application 21 generates image data displayed on the screen of the electronic paper 16 and detects the input of the operation unit 14 illustrated in FIG. 1. The video driver 23 is a device driver for controlling the screen display of the electronic paper 16. The video driver 23 writes image data displayed on the screen of the electronic paper 16 onto the VRAM 13 and controls the start and stoppage of the screen display of the electronic paper 16. The video driver 23 also obtains the various statuses relating to screen display. The writing of image data (screen display data (drawing data)) onto the VRAM is executed by the VRAM drawing unit 231. The VRAM drawing unit 231 writes image data onto the VRAM 13 according to an instruction from the application 21. When an image is displayed on the screen of the electronic paper 16, an electronic paper control unit 232 reads image data from the VRAM 13 and transmits it to the EP control unit 15. The EP control unit 15 displays (draws) the image on the screen of the electronic paper 16 on the basis of the image data received from the electronic paper control unit 232.

The input/output of a signal related to the control of the screen of the electronic paper 16 and a signal for obtaining its display status is performed by the electronic paper control unit 232. The electronic paper control unit 232 transmits/receives the above-described various signals to/from the EP control unit 15 which includes a driver IC (integrated circuit). The electronic paper control unit 232 reads screen display data from the VRAM 13 and transmits it to the EP control unit 15. The EP control unit 15 displays an image on the screen of the electronic paper 16 on the basis of the screen display data received from the electronic paper control unit 232.

The API layer 22 intermediates between the application 21 and the video driver 23 and includes a library and the like for the application 21 using various functions of the video driver 23. The application 21 writes (draws) image data onto the VRAM 13 using a standard drawing API provided for the API layer 22. The application 21 also requests the screen display control of the electronic paper 16 and the like from the electronic paper control unit 232, using API dedicated to electronic paper provided for the API layer 22.

### [Operation]

If a user inputs an instruction to display a subsequent screen from the operation unit 14 while the electric paper 16 is displaying a screen, the electric terminal 10 immediately stops the current screen display and immediately starts displaying a subsequent screen.

This display of a subsequent screen is classified into two of the case where the display of the entire screen is updated (full screen rewrite) and the case where the display of a partial area of the screen is updated (partial screen rewrite). In the case of the full screen rewrite, after the entire screen is reset once, raster scan is applied to the leading line of the screen through the last line and the image of the entire screen is updated. Meanwhile, in the case of the partial screen rewrite, only the image of a partial area of the screen is updated.

{First Embodiment of Subsequent Screen Display Sequence}

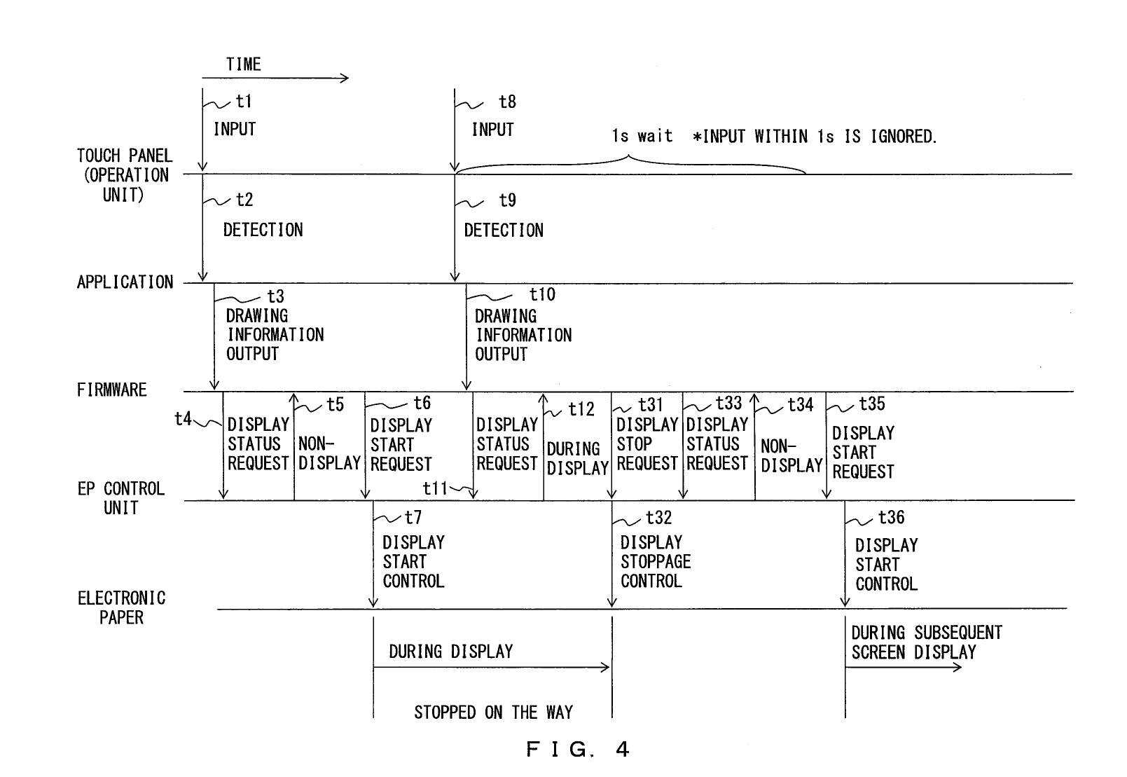

FIG. 4 illustrates the first sequence in the case where a user requests for a subsequent screen while the electronic paper is displaying a screen. In FIG. 4, the same reference numerals are attached to the same steps as those illustrated in FIG. 1 and the explanations of these steps are omitted or briefly explained.

The first sequence corresponds to the case where a subsequent screen is the display of the entire screen (full screen rewrite).

In the first sequence, firstly, the steps t1 through t7 illustrated in FIG. 1 and the electronic paper 16 starts displaying a screen. Then, when the user inputs an instruction to display a subsequent screen via the operation unit 14 while the electronic paper 16 is displaying a screen (t8), the application 21 detects this input (t9). Then, the same steps t10 through t12 as those in the sequence illustrated in FIG. 1 are executed and in step 12, the EP control unit 15 returns a display status of “non-display” to the firmware.

Upon receipt of the display status, the firmware transmits “display stop request” to the EP control unit 15 (t31). Upon receipt of the display stop request, the EP control unit 15 controls the electronic paper 16 to make the electronic paper 16 stop the screen display (t32).

Then, the firmware transmits “display status request” to the EP control unit 15 (t33). Upon receipt of the display status request, the EP control unit 15 returns “non-display” to the firmware as a display status (t34). Upon receipt of a display status of “non-display”, the firmware transmits “display start request” to the EP control unit 15 (t35). More specifically, after confirming that the electronic paper 16 is not displaying a screen, the firmware transmits a display start request to the EP control unit 15. At this moment, the firmware also transmits the “drawing information received from the application 21 ay step t10 to the EP control unit 15. Upon receipt of both the display start request and the drawing information from the firmware, the EP control unit 15 controls the electronic paper 16 to make the electronic paper 16 start displaying a subsequent screen on the basis of the drawing information (t36). This drawing information is composed of information for specifying a drawing area on a screen, and in the case of the partial rewrite of a screen, it includes the specification information, such as the leading and last lines of the drawing area and the like. It further includes information, such as the drive voltage setting value of the electronic paper, a driving time, times of drawing (one time of scan, three times of scan, etc.), a drawing direction and the like.

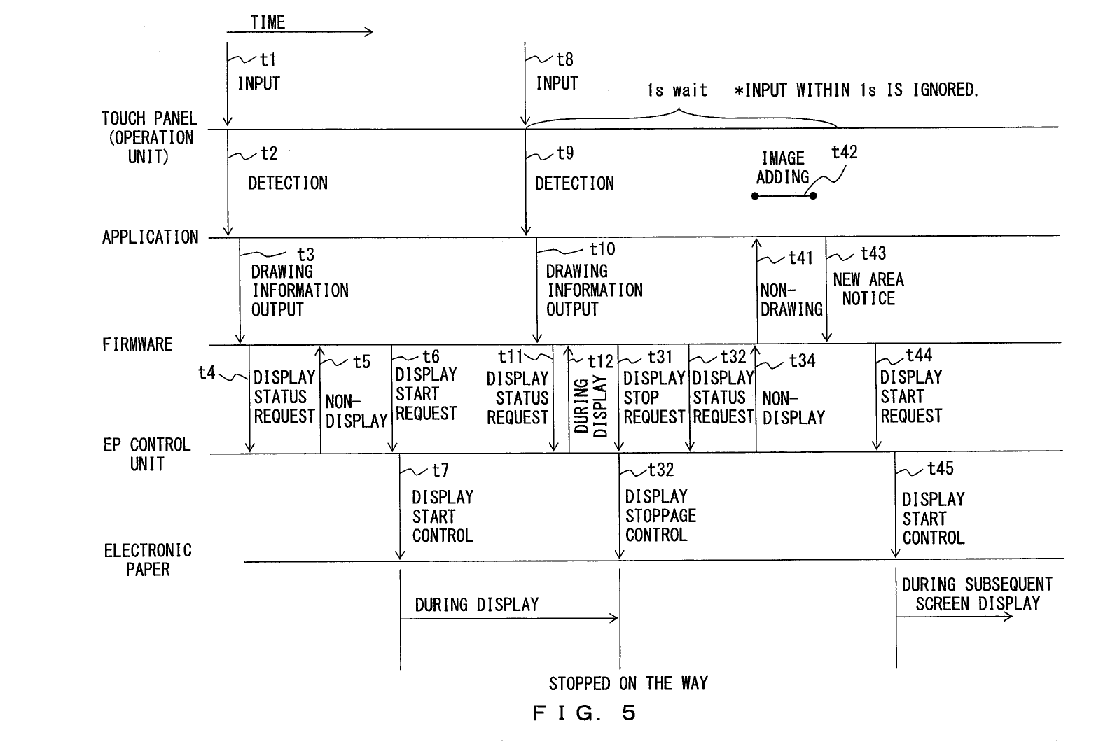

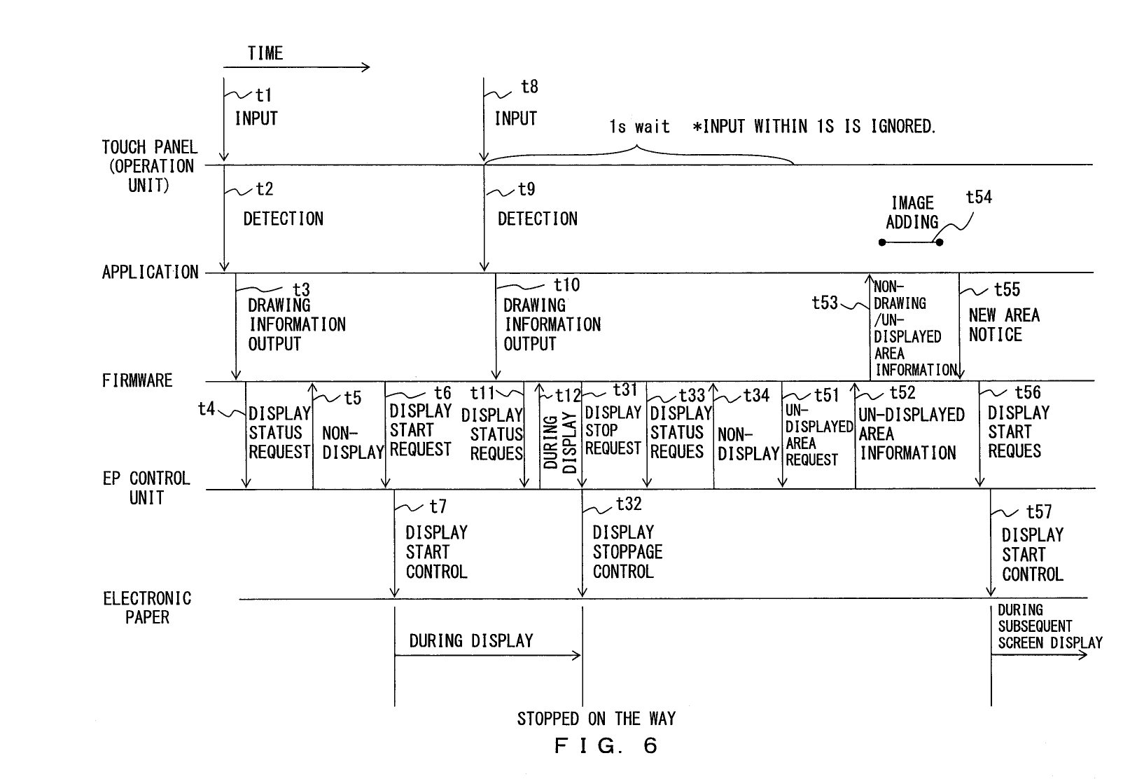

When the user inputs an instruction to display a subsequent screen from the operation unit 14 in step t8, other inputs from the operation unit 14 are ignored for one second after that. This is made in order to prevent a false operation due to the consecutive inputs of the user from the operation unit 14. This also applies to the sequence illustrated in FIGS. 5 and 6, which will be described later. The input waiting time of the operation unit 14 is not limited to one second.

According to the above-described first sequence, when a user inputs an instruction to display a subsequent screen from the operation unit 14 while a screen is displayed on the electronic paper 16, immediately the image of a subsequence screen requested by the user is displayed on the electronic paper 16. Therefore, the user can promptly read the image of the subsequent screen without being awaited for a long time. Thus, executing the first sequence, sensory speed at which the user reads a subsequent screen is improved, thus improving response performance to the user.

{Second Embodiment of Subsequent Screen Display Sequence (Partial Screen Rewrite (Case 1))}

FIG. 5 illustrates the second sequence in the case where a user requests for a subsequent screen while the electronic paper 16 is displaying a screen. Subsequent screen display in this case is for partial screen rewrite. In FIG. 5, the same reference numerals are attached to the same steps as those illustrated in FIG. 4 and the explanations of these steps are omitted or briefly explained.

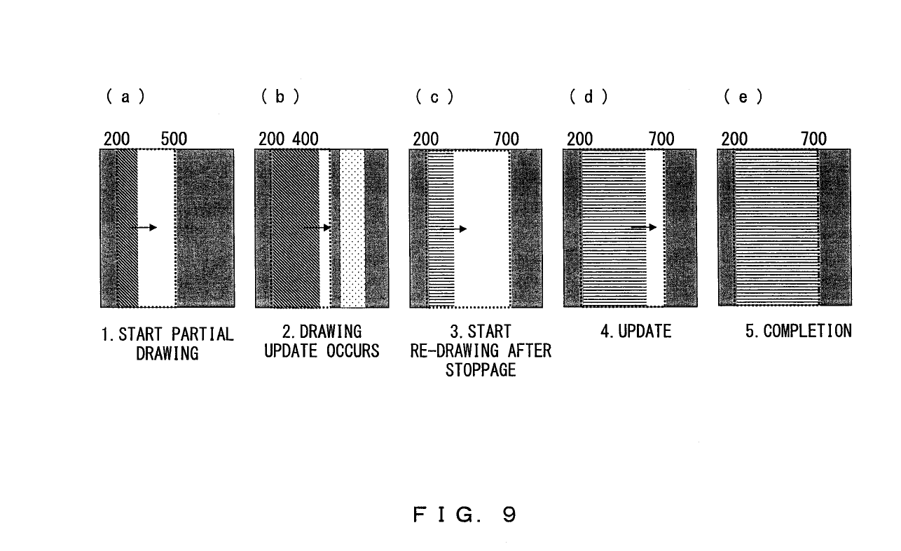

FIG. 9 illustrates a specific example in the case where this second sequence is applied.

FIG. 9 is the first embodiment of the screen display method of electronic paper 16 in the case where a user consecutively requests for the drawing of the partial area of a screen (hereinafter called partial drawing).

It is assumed that the user requests for displaying partial drawing of the 200-th through the 500-th lines and the partial drawing of the 200-th through the 500-th lines is started, as illustrated in FIG. 9A. Then, it is assumed that when the drawing of up to the 200-th through the 400-th lines is completed, the user requests for the partial drawing of the 600-th through the 700-th lines, as illustrated in FIG. 9B.

In this case, since the 401-th through the 500-th lines are not displayed yet, if the display of a subsequent screen is started from the 600-th lines, the 401-th through the 500-th lines remain in a reset state and are incompletely displayed. Therefore, as illustrated in FIG. 9C, after the 200-th through the 500-th lines are reset to white, drawing is started from the 200-th line again. Then, as illustrated in FIG. 9D, after the 200-th through the 500 lines are drawn, the 501-th line and after are newly drawn. Then, as illustrated in FIG. 9E, the drawing of the 200-th through the 700-th lines is completed.

If the partial drawing of lines after those of the partial drawing is instructed when the first partial drawing is not completed, the leading line of the first partial drawing area through the last line of a subsequent display area are drawn. Thus, after the first partial drawing is completed, the display of a subsequent screen can be started.

The second sequence of this embodiment, corresponding to the case illustrated in FIG. 9 will be explained below with reference to FIG. 5.

In the second sequence, steps t1 through t34 are the same as those in the first sequence illustrated in FIG. 4. Therefore, steps 33 and after will be explained below. When receiving “display status request” from the firmware in step t33 after stopping the screen display of the electronic paper 16, the EP control unit 15 returns a display status of “non-display” to the firmware (t34). Upon receipt of a display status of the “non-display” from the EP control unit 15, the firmware transmits a status of “non-drawing” to the application 21 (t41). Upon receipt of a status of “non-drawing”, the application 21 performs an “image adding process” (t42). This image adding process obtains an area (hereinafter called “aggregate area”) including a partial area in which the display is stopped (first partial area) and a partial area (second partial area) being the target of a subsequent screen display. In the example illustrated in FIG. 9, the aggregate area becomes the area of the 200-th through the 700-th lines.

When the image adding process is completed, the application 21 generates “new area information” and transmits a notice including the information (“new area notice”) to the firmware (t43). The new area information includes the leading and last lines of an area to be displayed in subsequent screen display (hereinafter called “new area”), a drawing direction and the like. In the example illustrated in FIG. 9, the leading and last lines of the new area are the 200-th and 700-th lines, respectively. In other words, this subsequent screen display target area is not an area specified as a subsequent screen by a user but an aggregate area including both a partial area which is previously instructed to draw whose display is stopped on the way (first partial area) and a partial area specified as a subsequent screen by the user this time (second partial area). The drawing direction is a scanning direction in the case of drawing the aggregate area and is determined on the basis of in which scanning direction drawing can be completed earlier, in the vertical or horizontal direction.

Upon receipt of the new area notice, the firmware transmits a “display start request” to the EP control unit 15 (t44). This request includes the information of the aggregate area as the display area information of a subsequent screen. Upon receipt of the display start request, the EP control unit 15 makes the electronic paper 16 start displaying a subsequent screen, that is, the new area, on the basis of the information of the subsequent display area included in the request (t45).

According to the above-described second sequence, when a user specifies a partial area as a subsequent screen while the electronic paper 16 is displaying the screen of a previously specified area (hereinafter called “previous specification area”), the display of the subsequent screen is started after the re-drawing of the previous specification area is completed. Therefore, the image of the previous specification area can be completely displayed. Furthermore, a response time until a subsequent screen is started can be shortened than before.

{Third Embodiment of Subsequent Screen Display Sequence (Partial Rewrite (Case 2))}

FIG. 6 illustrates the third sequence in the case where a user requests for a subsequent screen while the electronic paper 16 is displaying a screen. This third sequence is another method in the case where the same case as the above-described second sequence occurs. In FIG. 6, the same reference numerals are attached to the same steps as those illustrated in FIG. 5 and the explanations of these steps are omitted or briefly explained.

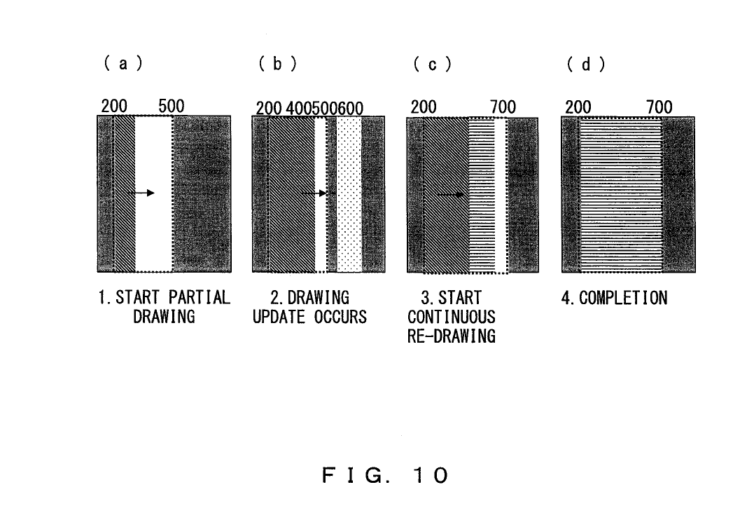

FIG. 10 illustrates a specific example in the case where this third sequence is applied.

FIG. 10 is the second embodiment of the screen display method of the electronic paper 16 in the case where a user consecutively requests for partial drawing.

It is assumed that a user requests for the display of the partial drawing of the 200-th through the 500-th lines and the partial drawing of the 200-th through the 500-th lines is started, as illustrated in FIG. 10A. Then, it is assumed that as illustrated in FIG. 10B, when the drawing of the 200-th through the 400-th lines is completed, the user requests for the partial drawing of the 600-th through 700-th lines. Up to here, the situation is the same as that in illustrated in FIGS. 9A and 9B.

Since the 401-th through 500-th lines are not dawn yet at the moment illustrated in FIG. 10B, if the display of a subsequent screen is started from the 600-th line, the display of the 401-th through the 500-th lines are incompletely displayed. Therefore, as illustrated in FIG. 10C, after the 401-th through the 700-th lines reset to white, the drawing of the 401-th through the 700-th lines is started from the 401-th line. Then, as illustrated in FIG. 10D, the drawing of the 401-th through the 700-th lines is completed. As a result, an area of the 200-th through the 700-th lines can be correctly displayed.

Specifically, in this method, if the partial drawing of the lines after those of the first partial drawing is instructed when the first partial drawing is not completed, the leading line of the un-displayed area in the first partial drawing through the last line of the display area of a subsequent screen are drawn. Thus, both the display of the first partial drawing and the display of a subsequent screen can be completed. In this method, a display area (the 401-th through the 700-th lines) is calculated on the basis of the information of an un-displayed area (the 401-th through the 500-th lines) and the information of a subsequent screen display area (the 600-th through the 700-th lines). In this example, the display area calculated thus is called “aggregate area” for convenience' sake. This aggregate area includes the un-displayed area in the first partial drawing and the display area of a subsequent screen.

The sequence in this embodiment, corresponding to the above-described case will be explained below with reference to FIG. 6.

Up to steps t34 are the same as those of the sequence illustrated in FIG. 4. Specifically, when receiving a “display status request” from the firmware in step t33 after stopping the screen display of the electronic paper 16, the EP control unit 15 returns a display status of “non-display” to the firmware (t34). Upon receipt of the “non-display” from the EP control unit 15, the firmware transmits an “un-displayed area request” to the EP control unit 15 (t51). This un-displayed area request is a command for requesting the EP control unit 15 to transmit the information of an un-displayed area. Upon receipt of this command, the EP control unit 15 returns “un-displayed area information” to the firmware (t52). This un-displayed area information includes, for example, the information of the leading and last lines of an area whose display is cut off in the middle due to display stoppage (un-displayed area), the latest line whose display is finished and the like. Upon receipt of the un-displayed area information, the firmware transmits the un-displayed area information to the application 21 together with a status of “non-drawing” (t53).

Upon receipt of those from the firmware, the Application 21 performs an “image adding process” and calculates an aggregate area including the above-described un-displayed area and a partial area specified this time (t54). Then, it transmits the information of the aggregate area to the firmware as a “new area notice” (t55). This new area notice includes the information of the leading and last lines of an area newly displayed in a subsequent display (new area). Upon receipt of the new area notice, the firmware transmits a “display start request” to the EP control unit 15 (t56). This display start request includes the leading and last lines of the new area. Upon receipt of the display start request, the EP control unit 15 controls the electronic paper 16 to start the display of a subsequent screen, that is, the added area on the basis of the information of the subsequent screen display area (new area) included in the request (t57).

According to the above-described sequence, even if a user instructs to display a subsequent screen (partial drawing, in this case) when the electronic paper 16 is displaying a screen previously specified by the user and the display of the specification screen is not completed yet, both the previously specified screen and a subsequent screen can be displayed without troubles. In the method illustrated in FIG. 6 (second method), the number of lines displayed in subsequent screen display is smaller than in the method illustrated in FIG. 5 (first method). Therefore, the response time until the entire subsequent screen of the second method is started is shorter than that of the first method.

{Entire Process Flow in the Second Embodiment of Subsequent Screen Display}

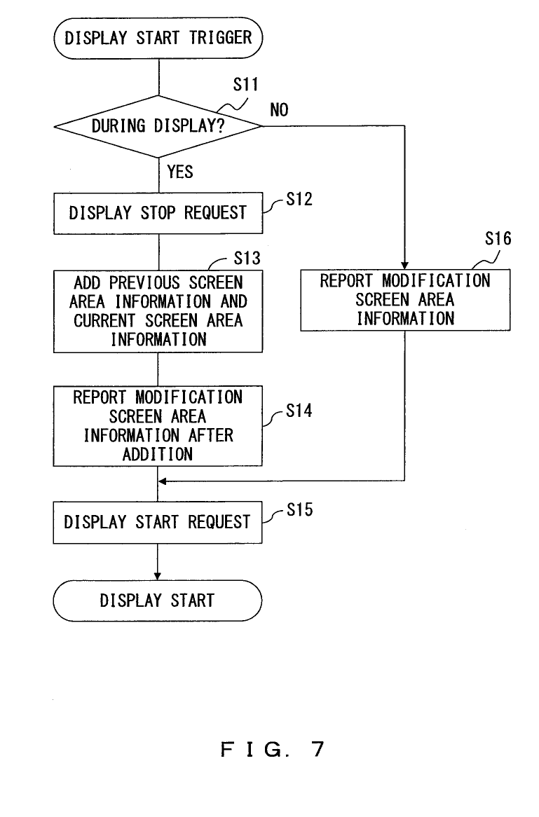

FIG. 7 is a flowchart illustrating the process algorithm in the second embodiment of the subsequent screen display illustrated in FIG. 5 of the major part of the present invention. The process of the flowchart illustrated in FIG. 7 is performed by the MPU 11 executing both the firmware and the application 21 when a user instructs to display a subsequent screen (transmits a display start trigger) from the operation unit 14.

The process algorithm in the second embodiment of subsequent screen display will be explained below with reference to FIG. 7.

Firstly, it is determined whether the electronic paper 16 is displaying a screen (step S11). This is determined by the firmware. The firmware receives a display status from the EP control unit 15 by transmitting a “display status request” to the EP control unit 15 and determines whether the electronic paper 16 is currently displaying a screen, on the basis of the display status.

If is the EP control unit 15 determines that the electronic paper 16 is displaying (YES in step S11), the firmware transmits a “display stop request” to the EP control unit 15 (step S12).

Upon receipt of the display stop request, the EP control unit 15 makes the electronic paper 16 stop the screen display. In this case, since the display is stopped, an un-displayed area remains in an area whose drawing is previously instructed (hereinafter called “previous drawing area”) and the un-displayed area is in a reset state, that is, remains white.

Then, an “image adding process” is performed by the application 21 (step S13). The application 21 calculates an aggregate area including both the previous drawing area and an area whose drawing is instructed this time (hereinafter called “current drawing area”) on the basis of both the information of the previous drawing area and the information of the current drawing area (step S13). The aggregate area calculated in step S13 is, for example, an area whose leading and last lines are the “leading line of previous drawing area” and the “last line of current drawing area”, respectively.

Then, the application 21 notifies the firmware of the information (hereinafter called “new drawing area information”), relating to the area calculated in step S13 (hereinafter called “new drawing area”) (step S14). This new drawing area information includes, for example, both the “leading line of previous drawing area” and the “last line of current drawing area”.

Upon receipt of the new drawing area information, the firmware transmits a display start request to the EP control unit 15 (step S15). This display start request includes the new drawing area information. The EP control unit 15 makes the electronic paper 16 start drawing (displaying) a new drawing area on the basis of the new drawing area information.

If in step S11 the firmware determines that the electronic paper 16 is not displaying a screen (NO in step S11), the application 21 transmits “modification screen area information” to the firmware (step S16). This modification screen area information is the same as the current drawing area information. Upon receipt of the modification screen area information, the firmware transmits a display start request to the EP control unit 15 (step S15). This display start request includes the modification screen area information. The EP control unit 15 makes the electronic paper 16 start displaying the modification screen area, that is, a subsequent screen specified by the user, on the basis of the modification screen area information.

By the above-described process, when a user requests for the display of the current drawing area while the previous drawing area is being displayed, the display of the previous drawing area is immediately stopped and the display of the leading line of the previous drawing area through the last line of the current drawing area is started. Thus, since the leading line of the previous drawing area through the last line of the current drawing area are displayed, both the previous and current drawing areas can be correctly displayed without the un-displayed portion of the previous drawing area is displayed in white. Furthermore, a response time until the current drawing area is started can be shortened than before.

{Entire Process Flow in the Third Embodiment of Subsequent Screen Display}

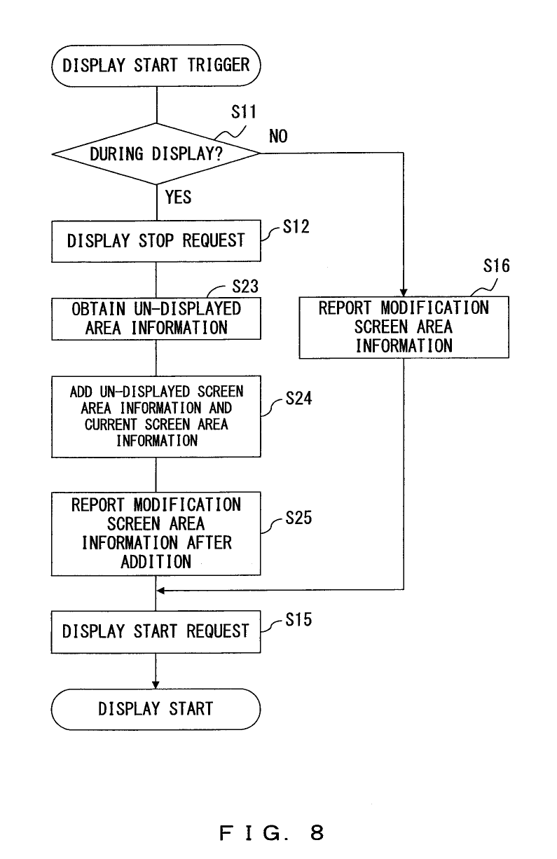

FIG. 8 is a flowchart illustrating the process algorithm in the third embodiment of the sequence of the subsequent screen display illustrated in FIG. 6, of the major part of the present invention. The process of the flowchart illustrated in FIG. 8 is performed by the MPU 11 executing both the firmware and the application 21 when a user instructs to display a subsequent screen (transmits a display start trigger) from the operation unit 14. In FIG. 8, the same reference numerals are attached to the same steps as those illustrated in FIG. 7 and their processes are briefly explained.

The process algorithm in the third embodiment of subsequent screen display will be explained below with reference to FIG. 8.

When a user instruct to display a subsequent screen while the electronic paper 16 is displaying a screen, the above-described processes in steps S11 and S12 illustrated in FIG. 7 are performed and the screen display of the electronic paper 16 is stopped.

Then, the firmware obtains the information of an area which is not displayed in the previous drawing area (hereinafter called “un-displayed area information”) from the EP control unit 15 and transmits it to the application 21 (step S23). The application 21 calculates the information of an area to be displayed as a subsequent screen (hereinafter called “modification screen area information”) on the basis of both the un-displayed area information and the current drawing area information which are received from the firmware (step S24). This modification screen area information includes the “leading line of un-displayed area”, the “last line of current drawing area” and the like.

The application 21 notifies the firmware of the modification screen area information calculated in step S24 (step S25). The firmware transmits a display start request to the EP control unit 15 (step S15). This display start request includes the modification screen area information received by the EP control unit 15 from the application 21. The EP control unit 15 makes the electronic paper 16 start displaying a subsequent screen on the basis of the modification screen area information. This subsequent screen is an area whose leading and last lines are the “leading line of un-displayed area” and the “last line of current drawing area”, respectively.

By the above-described process, when the display of the current drawing area is instructed while the electronic paper 16 is displaying the previous drawing area, the display of the electronic paper 16 is temporarily stopped. Then, the display of an area of the leading line of the un-displayed area of a previous drawing area through the last line of a current drawing area is started. Thus, when a user instructs to display the current drawing area while the previous drawing area is being displayed, the display of the current drawing area is temporarily stopped. Then, the leading line of the un-displayed area of the previous drawing area through the last line of the current drawing area is immediately started. Since the display stoppage time of the current drawing area is short, the user can immediately read the current drawing area.

The present invention is not limited to the above-described embodiments and various modifications can be made hereto without departing from the spirit of the invention.

For example, the subsequent screen display method of the present invention is not limited to the examples illustrated in FIGS. 9 and 10. For example, the display area of a subsequent screen can also be a partial area located before the screen currently displayed. Thus, the area of a previous screen whose display is stopped and the area of a subsequent screen can be variously combined depending on their locations and sizes. The present invention can promptly start displaying a subsequent screen in relation to these various combinations in such a way as not to affect image display.

Furthermore, the display device of the electronic paper of the present invention is not limited to a liquid crystal display and can also be another thin display.

1. A display control apparatus of electronic paper, for controlling display of electronic paper, comprising:
a detection unit for detecting an input for instructing to display a subsequent screen; and
a control unit for controlling electronic paper to stop screen display and start display of the subsequent screen if electronic paper is displaying a screen when an input for instructing to display a subsequent screen is detected by the detection unit.

2. The display control apparatus of electronic paper according to claim 1, further comprising
an acquisition unit for obtaining information of an un-displayed area in which an un-displayed portion results from stoppage of the screen display, wherein
the control unit controls electronic paper to display an image of the un-displayed area when determining that the subsequent screen display is display of a partial screen area of electronic paper and also the un-displayed area is not included a display area of the subsequent screen on the basis of the information of the un-displayed area obtained by the acquisition unit.

3. The display control apparatus of electronic paper according to claim 2, wherein
the control unit controls electronic paper to start display of the subsequent screen after re-displaying the entire un-displayed area.

4. The display control apparatus of electronic paper according to claim 2, wherein
the control unit controls electronic paper to start display of the subsequent screen after displaying an un-displayed portion of the un-displayed area.

5. The display control apparatus of electronic paper according to one of claim 1, wherein
a display device of the electronic paper is a liquid crystal display.

6. A display control method of electronic paper, for controlling display of electronic paper, comprising:
detecting an input for instructing to display a subsequent screen; and
controlling electronic paper to stop screen display and start display of the subsequent screen if electronic paper is displaying a screen when an input for instructing to display a subsequent screen is detected in the detection step.

7. The display control method of electronic paper according to claim 6, further comprising
obtaining information of an un-displayed area in which an un-displayed portion results from stoppage of the screen display, wherein
controlling electronic paper to display an image of the un-displayed area in the control step when it is determined that the subsequent screen display is display of a partial screen area of electronic paper and also the un-displayed area is not included a display area of the subsequent screen on the basis of information of the un-displayed area obtained in the acquisition step.

8. The display control method of electronic paper according to claim 7, wherein
electronic paper is controlled to start display of the subsequent screen after re-displaying the entire un-displayed area in the control step.

9. The display control method of electronic paper according to claim 7, wherein
electronic paper is controlled to start display of the subsequent screen after displaying an un-displayed portion of the un-displayed area in the control step.

10. The display control method of electronic paper according to one of claim 6, wherein
a display device of the electronic paper is a liquid crystal display.
